(19) United States
(12) Patent Application Publication
(10) Pub. No.: US 2007/0099680 A1
(43) Pub. Date: May 3, 2007

(54) Wearable caddy for a Personal Audio Device having integrated cord storage

(76) Inventor: Peter Kielland, Ottawa (CA)

Correspondence Address: J. GORDON THOMSON, P.O. BOX 8865, VICTORIA, BC, V8V 3Z1, CA

(21) Appl. No.: 11/163,874

(22) Filed: Nov. 2, 2005

(51) Int. Cl. H04M 1/00

(52) U.S. Cl. 455/575.1

(57) ABSTRACT

A wearable caddy for a personal audio device (PAD) adapted to mount at least one PAD and store excess earphone cord. The caddy comprises a front plate and a back plate joined by a plate separating member that creates a space between the plates adapted to store the excess cod by spooling the excess cord around the separating member. The PAD is mounted to the front surface of the front plate using a double-sided adhesive pad. A clear self-adhesive plastic cover is placed over the face of the PAD. More than one pad may be mounted to the same caddy. The caddy clips to the belt of the wearer and can be used to store earphone cord or heavier head-set cord.

### BACKGROUND

1. Field of the Invention

The present invention relates to carrying and storage devices and more particularly to a wearable caddy for a Personal Audio Device having integrated cord storage.

2. Description of the Known Art

Wearable portable music players in various formats such as MP3 music players, radios and compact disc players are well known and very popular. I shall refer to these devices as personal audio devices or PADs. Examples include the Apple iPod® and the Sony® Walkman®. PADs are usually attached to the arm or belt of the user and generally require the use of a listening device such as conventional headphones or miniature in-ear speakers (referred to hereafter as “earphones”) to listen to the player privately and in comfort. A thin wire attaches the player to the listening device. These fixed-length wires are typically provided with the PAD upon purchase. The wires are a standard length and adapted for listening device use by tall as well as short individuals. Therefore for shorter or average sized persons, there may be excess wire dangling from the PAD. For an active individual, either walking or running, the excess wire can interfere with body movement resulting in the dislodgement of the listening device. Due to the length of the wire the listening device can drop from the head to the ground. This is at least a recurring nuisance and can damage the device. In other conditions the wire can be a snagging hazard and increase the risk of tripping the user or entangling in a moving object such as a rotating bicycle wheel. Users will often attempt to modify the length of the wire to a desired length by storing the excess wire in a pocket or by using a rubber band or wire tie to wrap the excess wire into loops. These temporary solutions are not effective because they can unravel and thereby create impediments to the easy and comfortable enjoyment of the PAD.

More formal attempts have been made to overcome some of these disadvantages. One example is U.S. patent application Ser. No. 11/027,405 by Mr. Bill Tsand Chun Chee published on Jul. 7, 2005 and entitled “Headset Cord Retainer”. The Chee device comprises a spool about which the excess wire is wrapped. The audio plug and the earphones extend from the spool through slots. In operation, the device is positioned between the earphones and the PAD. When not in use the device acts as a separate storage device for the PAD earphone-cord and earphone. One disadvantage associated with this device is the fact that the cord is stored apart from the PAD. Loss of the Chee device with the cord enclosed will render the PAD inoperable. Another disadvantage associated with the Chee device is that it forms yet another body that must be hand held by the user, left free to hang or attached to the user's clothing in some fashion to prevent the device from moving with the body movement of the user.

Another example of the know art is U.S. Pat. No. 5,984,224 issued to Bill Yang on Nov. 16, 1999 and entitled “Cable-Spooling Casing for Earphones”. One disadvantage of the Yang invention is that it does not permit mounting of a PAD to the spooling device and is worn separate from the PAD.

Therefore there exists disadvantages and shortcomings in the known art of which the present invention seeks to overcome.

### SUMMARY

In accordance with one embodiment of the present invention there is provided a base comprising a front plate having a front surface and a back surface, a back plate having a front surface and a back surface, a plate separating body having a top surface and a bottom surface thereby creating a space between the two plates and a spring clip fixed to the top end of the back plate having a top curved surface a biased clip portion adapted to clasp to a wearers belt or pocket and a flared lip adapted to permit easy attachment to a wearer's belt or pocket. The spring clip is integral to the back plate. There is a plate separating body adapted to create a predetermined distance between the front plate back surface and back plate front surface sufficient so that a cord can be easily wrapped within the space. The cord is wrapped around the separating body in concentric coils. A portable PAD such as an ipod-type device or a small radio is mounted to the front plate front surface by a dual-sided adhesive strip.

In another embodiment of my invention a dual sided piece of VELCRO® can be used to fasten the portable PAD to the base.

In yet another embodiment of my invention a self-adhering clear plastic cover is placed over the face of the portable music device to keep it waterproof and clean.

In one embodiment of my invention there is a plurality of cutouts in the back plate for holding the cord in place while it is used to hang the base around the neck of the wearer.

In another embodiment of my invention the back plate has a front surface and a back surface. The front surface of the back plate includes two stubs and that are adapted to press fit into recesses on the back surface of the front plate. Once the back plate is joined to the front plate the raised discs create a space between the front surface of the back plate and the back surface of the front plate sufficiently wide to accommodate the diameter of excess cord wrapped around the two raised discs. This embodiment is particularly suited for manufacturing the front and back plates using thermoplastics and injection molding techniques.

In still another embodiment of my invention there is included a left side bracket, a right side bracket and a bottom bracket. This embodiment is adapted to hold a portable PAD that is augmented with an amplifier module for powering, for example, head phones. The module includes a volume control dial and a port for inserting an audio plug.

In still another embodiment of my invention an amplifier and battery module is mounted to a bottom bracket on the front plate. The module may include a microphone, a thumbwheel for volume control, a three-way toggle switch having a first position corresponding to the amplifier on, a second position corresponding to the amplifier off and a third position corresponding to the amplifier on/microphone on so that the wearer can hear ambient sounds or a conversation. The portable music device docks with a post on the module and thereby connects its internal power source with the module supplementary battery. A standard USB port can also be provided in the module.

In one embodiment of my invention the base is sold separately apart from the portable PAD. However, another embodiment of my invention has the portable PAD is sold as a kit including the base and clear cover.

In another embodiment of my invention the base comprises a first pod and a second pod. The second pod is disposed from the first pod by a flat plate. The two pods and the flat plate are molded as one piece from suitable thermoplastic materials. A spring clip is attached to the back surface of each pod to adhere to the wearer in a variety of orientations.

In still another embodiment of my invention a loop can be used to mount the base and portable music device combination to a waist belt.

In another embodiment of my invention, the two pods have removable front surfaces that enclose a chamber. The chamber can be used to contain additional batteries, small radio circuits and amplification devices to power head phones. These devices can be operatively connected to an iPod-type device through a docking post. The first pod and second pod have recessed front surfaces creating ridges around the first and second pods so that an iPod-type device will sit on the recessed front surfaces and adhere to them using double-backed adhesive pads. The ridges prevent the portable PAD from slipping off of the base in an up, down or sideways direction. The portable PAD can be fixed to the base using cinctures, elastic bands, VELCRO® straps, and clamps or placed in a casing that is in-turn fixed to the base. Two portable PADs may be attached to the base by fixing one to the front surface and one to the back surface of the base using double-backed adhesive pads and cinctures.

### Objects and Advantages

Accordingly, besides the objects and advantages of my wearable cord storage apparatus described above, several objects and advantages of my invention are:

to provide an improved wearable apparatus for conveniently storing excess cord of a portable PAD;

to provide a convenient, wearable device for carrying a portable PAD;

to provide a minimally visible carrier for a portable PAD that also protects the PAD from abrasions;

to provide a wearable apparatus that can be used to amplify the audio signal of a portable PAD so that a headphone can be provided with a higher fidelity signal;

to provide a wearable apparatus that can be used to provide supplemental battery power to a portable PAD;

to provide a wearable apparatus than can simultaneously mount a portable PAD and a radio;

to provide a wearable apparatus wherein the earphone cord can be used to make a lanyard for hanging the portable PAD around the neck of the wearer;

to provide a wearable apparatus that is easy to construct from molded thermoplastic materials and inexpensive to operate; and,

to provide a wearable apparatus that can be sold as a kit with a portable PAD.

Still further objects and advantages of our invention will become apparent from a consideration of the following diagrams and detailed description.

### DESCRIPTION OF THE DRAWING FIGURES

FIG. 1 illustrates a typical ipod-type portable PAD mounted on the apparel of a wearer.

FIG. 2 shows a preferred embodiment of my invention.

FIG. 3 shows an alternate embodiment of the front and back plates of my invention adapted for ease of manufacture.

FIG. 4 shows how cord from the portable PAD can be used to create a lanyard to hang the portable PAD around the neck of the wearer.

FIG. 5 shows a side view of the embodiment in FIG. 4.

FIG. 6 shows an oblique side view of another embodiment of my invention.

FIG. 7 shows a side view of the same embodiment as FIG. 6.

FIG. 8 shows an oblique front view of another embodiment of my invention mounting an amplifier module.

FIG. 9 shows an oblique front view of yet another embodiment of my invention.

FIG. 10 shows a side view of the same embodiment as FIG. 9.

FIG. 11 shows an embodiment of the invention using a loop adapted to hang from the waist belt of a wearer.

FIGS. 12a to 12c show front, side and top views of one embodiment of my invention comprising a pair of pods joined by a flat plate.

FIG. 13 shows yet another embodiment of my invention wherein each pod includes a chamber.

FIG. 14 shows the embodiment of FIG. 13 mounting a portable PAD.

FIGS. 15a to 15c shows various embodiments fastening devices to fasten the portable PAD to my invention.

FIG. 16 shows an ipod-type device and a small radio mounted to opposite sides of my invention.

FIG. 17 shows an ipod-type device mounted to my invention and hung around the neck of the wearer from a lanyard made from excess cord.

FIG. 18 shows the same embodiment of my invention as FIG. 16 wherein a pair of full-sized headphones is used.

FIGS. 19a and 19b show how the preferred embodiment of my invention can be worn on a belt carrying more than one PAD.

### DETAILED DESCRIPTION

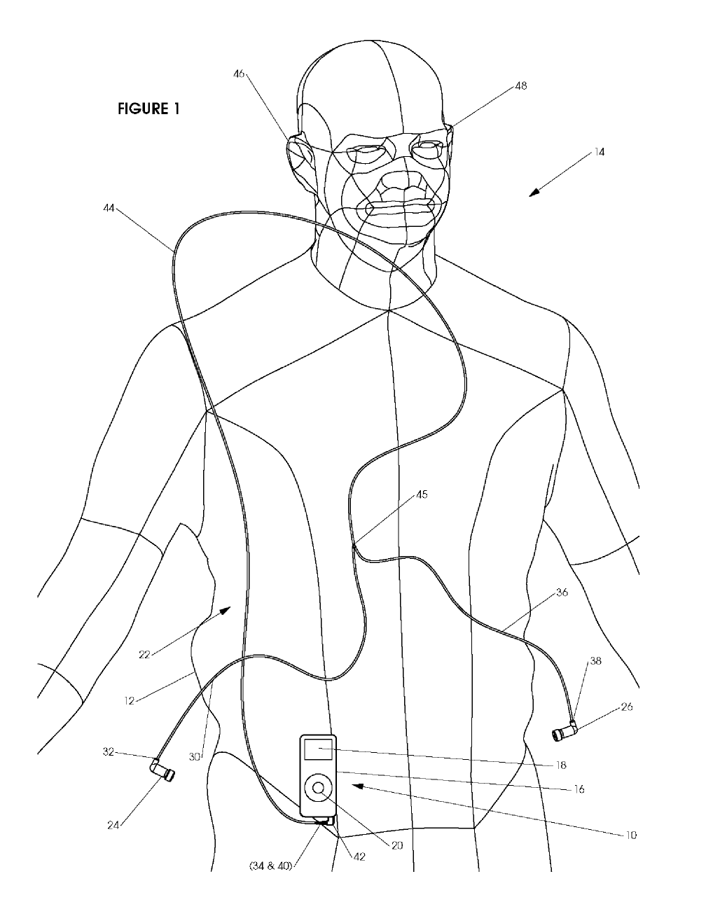

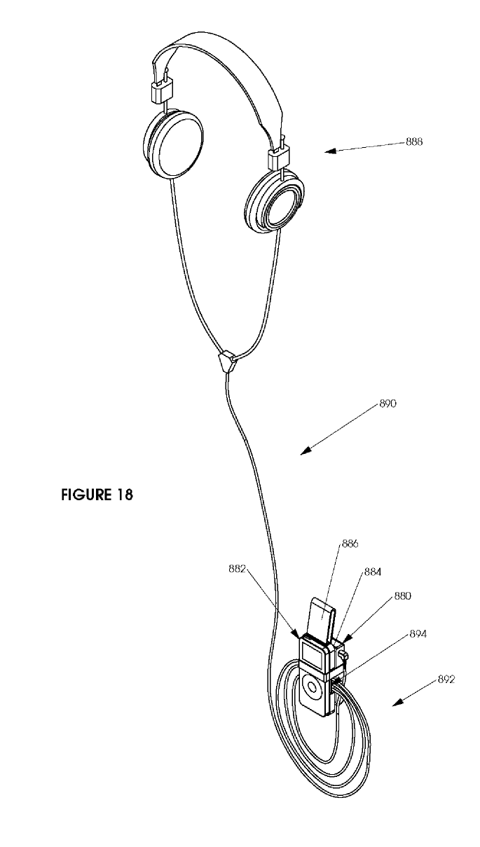

Referring to FIG. 1, there is shown a typical portable PAD (10), such as an iPod®, fixed to the apparel (12) of the wearer (14). The portable PAD comprises a player body (16) containing internal power means (not shown), internal amplification means (not shown), digital music processing means (not shown) a display (18) and a control pad (20). A cord (22) attaches a listening device (24 & 26) such as or earphones (shown in FIG. 1) or full-sized headphones (shown in FIG. 18). The cord (22) comprises a first wire (30) having a first end (32) and a second end (34) and a second wire (36) having a first end (38) and a second end (40). Attached to the first end (32 & 38) of each wire (30 & 36) is, as shown in FIG. 1, a listening device such as an earphone (24 & 26) for insertion into the wearer's ears (46 & 48). The cord (22) transmits electrical signals from the portable PAD to the earphones or headphones. The second ends (34 & 40) of the two wires (30 & 36) are attached to an audio plug (42) adapted for connecting the listening devices to the portable PAD (10). The cord (22) comprises the first wire and the second wire bound together in a parallel configuration over a first cord length (44) extending from the audio plug (42) to a point of bifurcation (45). At the point of bifurcation, the cord splits into two wires running to each sound device. As FIG. 1 illustrates the cord is adapted to fit a wide range of heights of wearers. For taller individuals, the cord length is sufficient to reach the ears (46 & 48) of the wearer without a large excess of cord hanging down from the ears. As previously mentioned, for shorter individuals there may be a large length of cord that is excess to the required length to reach the ears of the wearer. This cord can cause distractions and get snagged in body movements thereby dislodging the listening device. Users may wear the PAD at belt height as shown or elect to clip it to an armband or shirt-pocket, thereby exacerbating the excess-cord problem. Therefore, to resolve this problem, my invention is adapted to conveniently store the excess cord length so that it does not encumber the wearer.

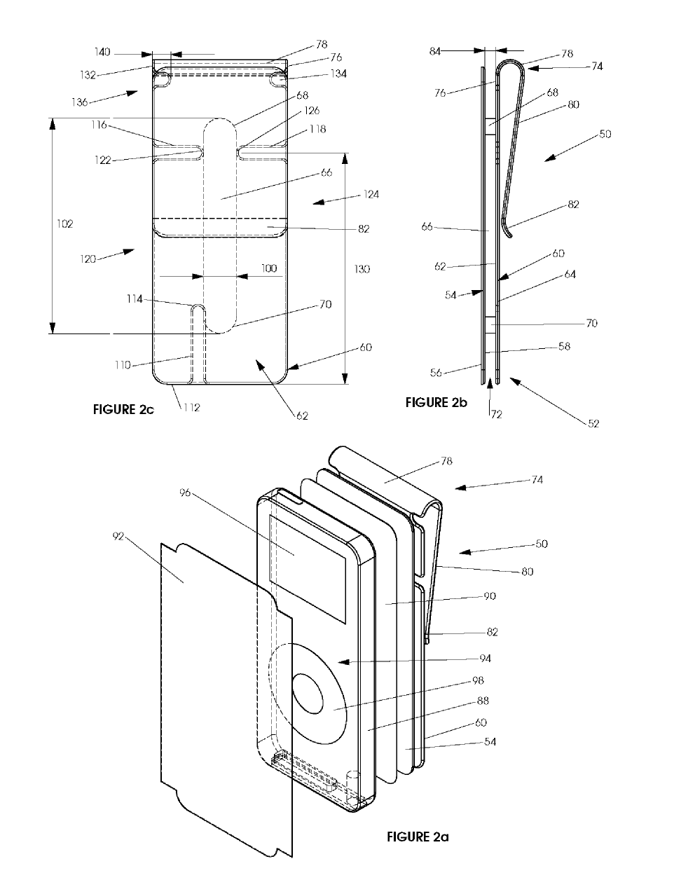

The preferred embodiment of my invention (50) is illustrated in FIG. 2a to FIG. 2c. In FIGS. 2a to 2c my invention comprises a base (52) comprising a front plate (54) having a front surface (56) and a back surface (58), a back plate (60) having a front surface (62) and a back surface (64), a plate separating body (66) having a top surface (68) and a bottom surface (70) creating a space (72) between the two plates and a spring clip (74) fixed to the top end (76) of the back plate (60) and having a top curved surface (78) a biased clip portion (80) adapted to clasp to a wearer's belt or pocket and a flared lip (82) adapted to permit easy attachment to a wearers belt or pocket. The spring clip in this embodiment is integral to the back plate (60). Other embodiments of the spring clip (not illustrated) may be comprised of a separate, independently biased and hinged member. The separating body may have curved top and bottom surfaces as illustrated or flat top and bottom surfaces. The plate separating body (66) is adapted to create a distance (84) between the front plate back surface (58) and back plate front surface (62) sufficient so that a cord can be easily wrapped within the space (72). The cord is wrapped around the separating body (66) in concentric coils. Portable PAD (88) is mounted to the front plate (54) front surface (56) by a dual-sided adhesive strip (90). In another embodiment a dual sided piece of VELCRO® having a male side and a female side can be used to fasten the portable PAD (88) to the base (52). In the preferred embodiment my invention includes clear plastic cover (92) that is self-adhering to the face (94) of the PAD (88) to protect it while permitting viewing of the display screen (96) and manipulation of the control pad (98).

Referring to FIG. 2c, there is illustrated a view of the front surface (62) of the back plate (56) of this embodiment of the base showing additional features. The separating body (66) has a width (100) and a length (102) and is disposed centrally on the surfaces (58) and (62) of the front and back plates. The length and width of the separating body is such that there is sufficient area between the front and back plates to accommodate a desired length of cord wrapped around the separating body. The spring clip (80) extends approximately halfway down the back surface (64) of the back plate (60). View 2c illustrates a plurality of cutouts in the back plate (60). First cutout (110) is located at the bottom end (112) of the back plate and to the left of the separating body (66). The first cutout extends upwards to a point (114) that is above the bottom curve (70) of the separating body. The second (116) and third (118) cutouts are disposed opposite each other across the separating body (66). Cutout (116) extends from the left side (120) of the back plate to a point (122) adjacent to the separating body. Cutout (118) extends from the right side (124) of the back plate to a point (126) adjacent to the separating body. Cutouts (116) and (118) are located a distance (130) from the bottom (112) of the back plate which is about three-quarters the way up the back plate. Cutouts (132) and (134) are disposed opposite each other at the top end (76) of the back plate at the point (136) where the clip (74) is attached to the back plate. The depth (140) of each of the cutouts (132) and (134) is approximately twice the diameter of the cord held within the base.

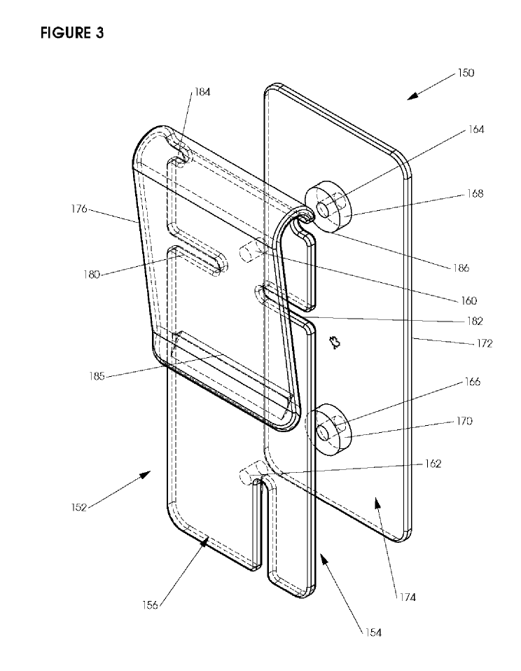

Referring now to FIG. 3 there is illustrated another embodiment of the back plate of my invention (150) wherein the back plate (152) has a front surface (154) and a back surface (156). The back surface (156) includes two stubs (160) and (162) that are adapted to press fit into recesses (164) and (166) penetrating raised discs (168) and (170). Once the back plate (152) is jointed to the front plate (172) the raised discs create a space between the front surface (154) of the back plate and the back surface (174) of the front plate sufficiently wide to accommodate the diameter of excess cord wrapped around the two raised discs. This embodiment is particularly suited for manufacturing the front and back plates using thermoplastics and injection molding techniques. The positioning of the clip (176) and the cutouts (178, 180, 182, 184 and 186) is the same as the embodiment shown in FIG. 2. In this embodiment there is included a gripping bar (185) that has a serrated edge for better gripping the apparel of the wearer.

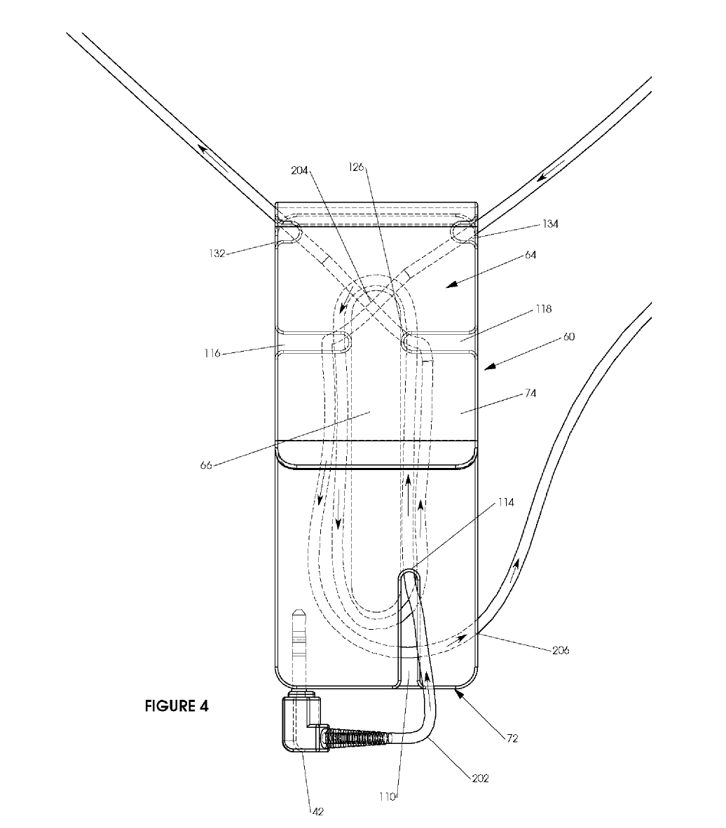

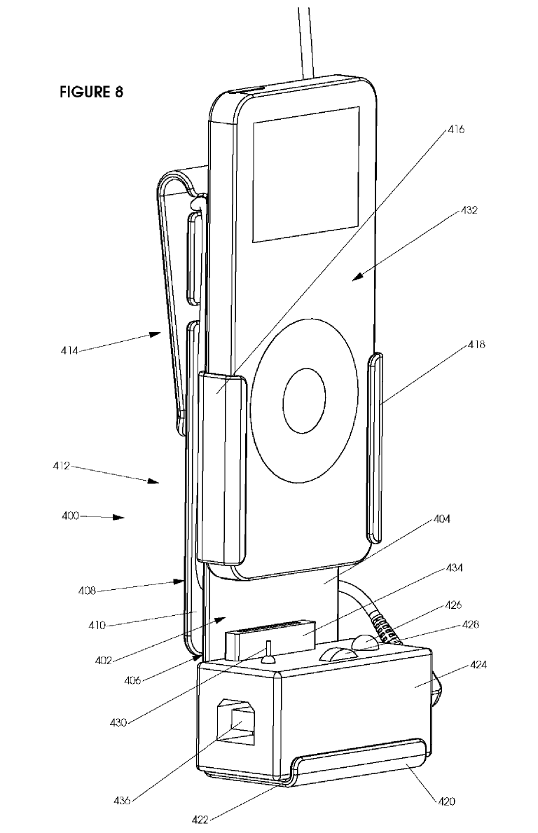

Referring now to FIG. 4, there is shown a view of the back surface (64) of the back plate (60) of the embodiment shown in FIG. 2. Audio plug (42) is shown in the position where it would connect with the portable PAD (94) in FIG. 2. Cord (202) runs from the audio plug and enters space (72) between the front and back plates at the top end (114) of first cutout (110). The top end (114) of the first cutout is a pinch-point that holds the cord tightly so as to reduce the tension on the audio plug. The cord (202) wraps around the separating body (66) and then exits the space (72) at cutout (118). Pinch-point (126) secures the cord. The cord then runs under the clip (74) and exits from the clip. From there the cord wraps around the neck of the wearer and returns to the clip where it crosses itself at point (204) and re-enters space (72) at cutout (116) behind the clip. The cord wraps around the separation body and exits the space at point (206) whereupon it travels to the listening device. Alternatively (not illustrated here but evident in FIG. 8), the cord may continue routing up within space (72) and out through slot (134) whereupon it is pinched and runs horizontally under clip (74) towards its opposite end, whereupon it exits and travels to the listening device. This manner of using the cutouts to pinch the cord in a plurality of places secures the cord in a manner that is able to carry the weight of the combined base and portable PAD and may optionally secure the free end of the cord where it exits the base.

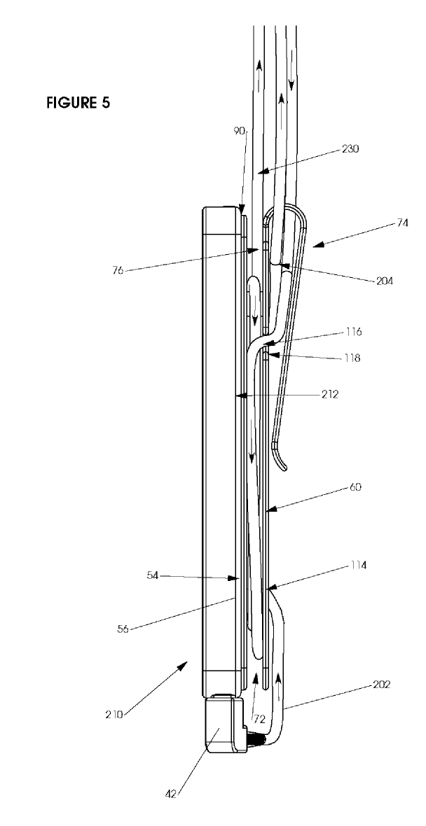

Referring now to FIG. 5, there is illustrated a side view of the same embodiment of my invention as illustrated in FIG. 4. Portable PAD (210) is shown mounted to the front surface (56) of the front plate (54) by way of a double backed adhesive fastener (90) between the back surface (212) of the portable PAD and the front surface (56) of the front plate. Audio plug (42) is inserted into the portable PAD. Spring clip (74) is illustrated mounted to the top (76) of back plate (60). Cord (202) enters space (72) at point (114) and travels around the separating member exiting at cutout (118). The cord travels around the neck of the wearer, crosses over itself at point (204) and re-enters space (72) at cutout (116) travels down the side of the separating member facing the viewer, around the opposite side of the separating body and then out to the listening device at the end of wire (230).

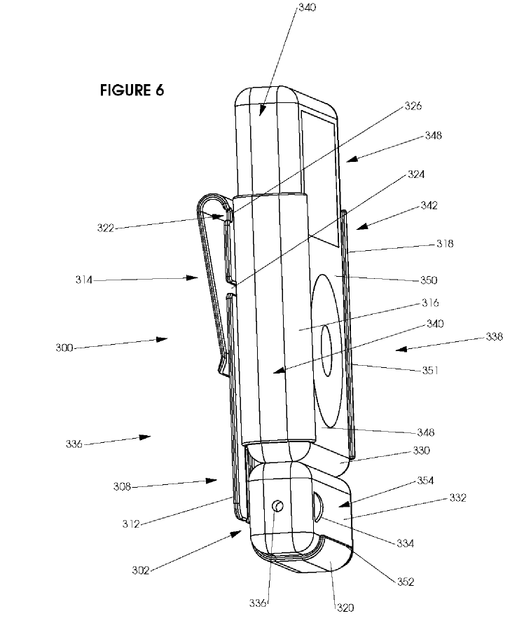

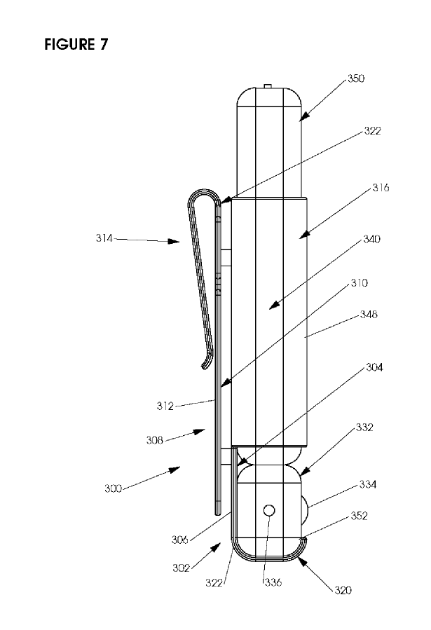

Now referring to FIG. 6 and FIG. 7, there is shown another embodiment of my invention (300) in oblique and side views respectively. This embodiment of the invention comprises a front plate (302) having a front surface (304) and a back surface (306), a back plate (308) having a front surface (310) and a back surface (312), a spring clip (314), a left side bracket (316), a right side bracket (318) and a bottom bracket (320). Spring clip (314) is fixed to the top end (322) of the back plate (308). The back plate (308) includes the same five cutouts as the embodiment shown in FIG. 4 with only cutout (324) and cutout (326) visible in this FIG. 6. This embodiment is adapted to hold a portable PAD (330) that is augmented with an auxiliary electronics module (332) which contains, for example, a high quality amplifier for powering head phones. Other complementary electronics hardware may be contained within said module, for example: auxiliary batteries, auxiliary FM radio, auxiliary radio transmitter for broadcasting to a nearby car radio etc. The electronics module (332) communicates with the PAD (330) via a mating dock connector (hidden in this view). The module includes a volume control dial (334) and a port (336) for inserting an audio plug. The left side bracket (316) and the right side bracket (318) are mounted and integral to the left (336) and right (338) sides respectively of the front plate (302) so that their respective concave sides (340) and (342) face each other. The brackets are shaped to generally conform to the shape of the sides and of the portable PAD. The front edges (348) and (350) of each side curve slightly inwards so that they contain the front surface (350) of the portable PAD and prevent is from toppling out of the base. In this embodiment, the bottom bracket (320) of the front plate extends from the bottom edge (322) of the front plate (302). The shape of the bottom bracket is adapted to the shape of the module (332) with the front edge (352) of the bottom bracket curved upwards to contain the front surface (354) of the module so that it does not slip out of the bottom bracket. The side brackets possess a suitable amount of resiliency so that when the portable PAD is inserted between them they are in a secure grasping contact with the sides of the portable PAD.

Referring now to FIG. 8, there is shown yet another embodiment of my invention (400) comprising a front plate (402) having a front surface (404) and a back surface (406), a back plate (408) having a front surface (410) and a back surface (412), a spring clip (414), a left side bracket (416), a right side bracket (418) and a bottom bracket (420). In this embodiment there is mounted to the top surface (422) of the bottom bracket (420) an amplifier and battery module (424). The module (424) includes a microphone (426), a thumbwheel (428) for volume control, a three-way toggle switch (430) having a first position corresponding to the amplifier on, a second position corresponding to the amplifier off and a third position corresponding to the amplifier on/microphone on so that the wearer can hear ambient sounds or a conversation without have to remove the earphones. Other control modes may be implemented, for example: to permit recording sounds from the microphone into the memory of the portable music device. The PAD (432) docks with post (434) and thereby connects any electronic circuits that are required between the two modules. A standard USB port (436) is also illustrated so that the wearer can dock the invention/portable PAD combination with a computer for downloading additional music. The USB port also acts to charge both the internal power source of the portable PAD as well as the supplemental battery contained in the module.

Referring back to FIG. 2a to 2c, one embodiment of my invention (50) is sold separately apart from the portable PAD (94). However, another embodiment of my invention has the portable PAD is sold as a kit including the invention (50).

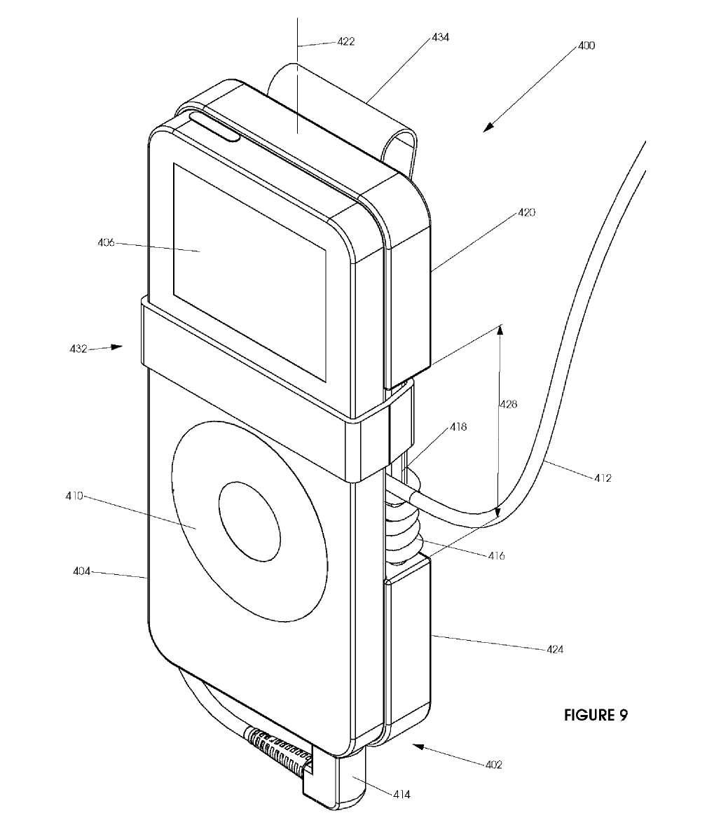

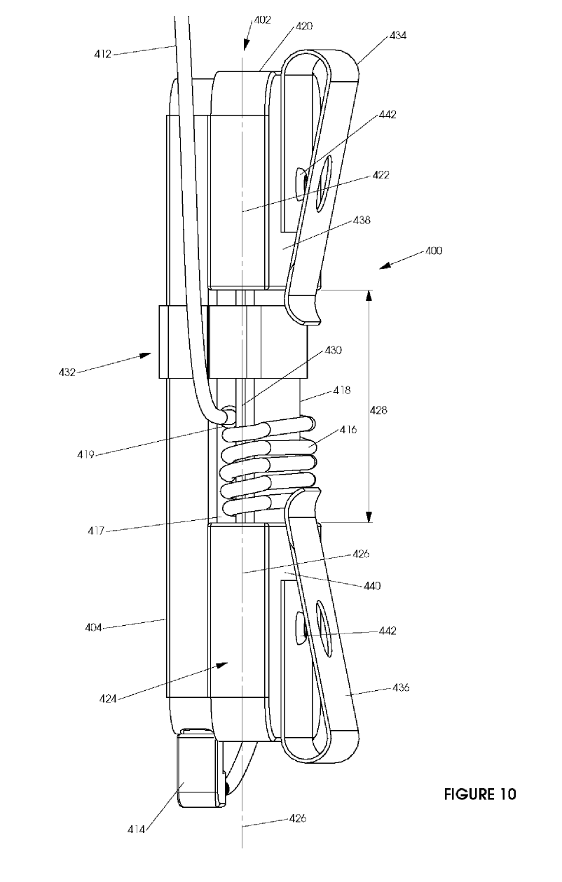

Referring to FIG. 9 and FIG. 10, there is shown another embodiment of my invention (400) front oblique view and side view respectively. My invention comprises a base (402) onto which the portable PAD (404) is mounted. The portable PAD has a display screen (406) and control pad (410) and other well-known features normally associated with such devices. The portable PAD has a listening device (not shown) that is attached to the portable music device by way of cord (412) and audio plug (414). As more fully explained below, the wearer can spool excess cord (416) around the flat plate (418) in a convenient and expedient manner. The base (402) comprises a first pod (420) having a first vertical axis (422) and a second pod (424) having a second vertical axis (426). The second pod (424) is disposed from the first pod (420) a predetermined distance (428) such that the first vertical axis (422) and the second vertical axis (426) are co-axial. There is also a flat plate (418) having a third vertical axis (430). The flat plate has a length equaling the predetermined distance (428) and joins the first and second pods as illustrated. The two pods and the flat plate are molded as one piece from suitable thermoplastic materials. Also shown in FIG. 9 is one embodiment for mounting the portable PAD (410) to the base (402). In the FIGS. 9 and 10, the portable PAD is mounted to the base by at least one cincture (432) comprising one of an elastic band, a VELCRO® band or a preformed and resilient plastic band. The cincture (432) is adapted to wrap around the base (402) and the portable PAD (404) thereby holding the portable PAD securely to the base. As further explained below there are other means possible to couple the portable PAD to the base. Means to couple the combined base and portable PAD to the wearer comprise at least one spring clip (434) that is adapted to fasten to the waist belt or pocket of the wearer. As illustrated in FIG. 10, there can be 2 such spring clips (434) and (436) so that the combined base and portable PAD can be mounted and oriented in a variety of positions. The spring clips are fastened to the back surface (438) of the first pod (420) and the back surface (440) of the second pod (424) by fixed or pivoting fastening means (442) such as screws, pins or rivets or by suitable adhesives. In another embodiment of my invention the spring clips may be removable from the back surface of the two pods. The spring clips advantageously attach to an arm band of the wearer so that the portable PAD can be worn during active sports or exercise.

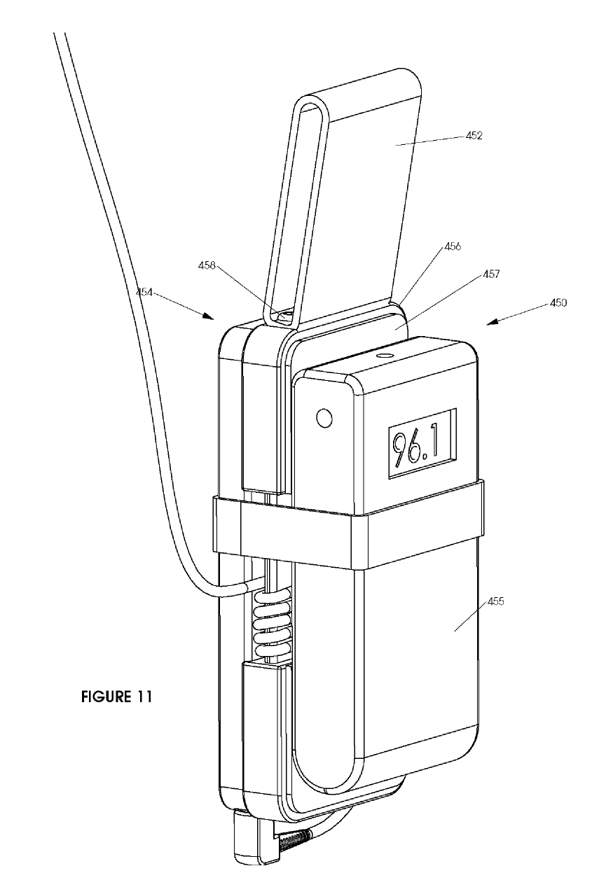

Referring to FIG. 11 there is shown another embodiment of my invention (450) in which means to fasten the invention to the wearer comprises a loop (452) fixed to the top surface of the base (456) by fixing means such as a screw or rivet (458). The loop is adapted to be threaded onto the waist belt of the wearer. In this embodiment a first PAD (455) is attached to one side of the base and a second, complementary PAD (454) is attached to its opposite side.

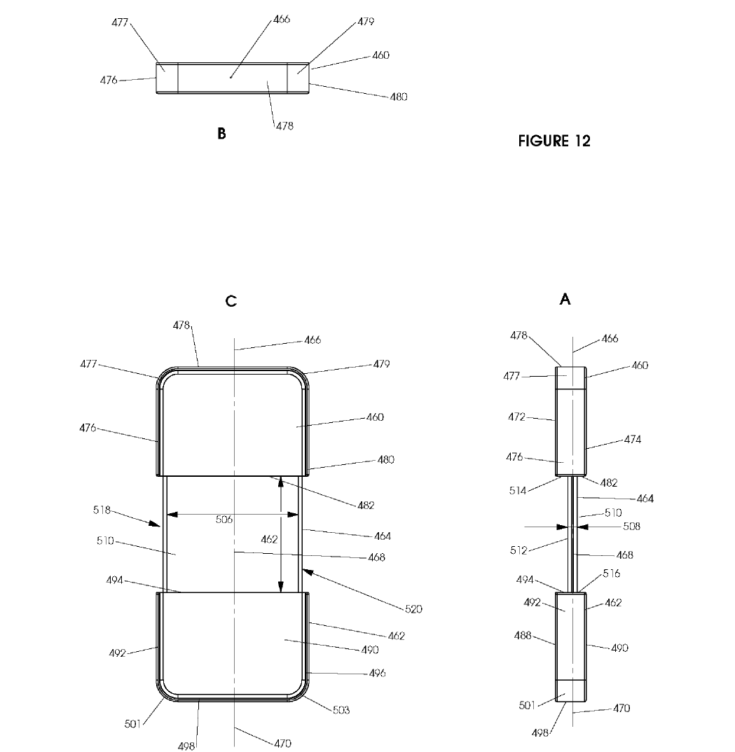

Referring now to FIG. 12a to 12c, there is shown additional detail of the base (456) of my invention (450) illustrated in FIG. 11 without belt loop (452). FIG. 12a shows the base in an elevation side view. FIG. 12b shows a top view of the base and FIG. 12c shows a front view of the base. The base comprises a first pod (460), second pod (462) and flat plate (464) joined so that their respective axis (466, 468 and 470) are co-axial. The first pod (460) comprising a back surface (472), a front surface (474), a left side (476), a top side (478), a right side (480) and a bottom side (482). The top side (478) is joined to left side (476) and right side (480) by curved shoulders (477) and (479) respectively. The second pod (462) comprises a back surface (488), a front surface (490), a left side (492), a top side (494), a right side (496) and a bottom side (498). The second pod left side (492) and right side (496) are joined to the bottom side (498) by way of curved shoulders (501) and (503) respectively.

Still referring to FIG. 12, the flat plate (464) has a length (462), a width (506), a thickness (508), a front flat surface (510), a back flat surface (512), a top end (514), a bottom end (516), a left side (518) and a right side (520). The top end (514) of the plate is fixed to the bottom side (482) of the first pod and the bottom end (516) of the plate is fixed to the top side (494) of the second pod. The front surfaces (474 and 490) and the back surfaces (472) and (488) of the first and second pods are co-planer.

The width (506) of the flat plate (464) is slightly less than the widths of the first (460) and second (462) pods so that when a cord is spooled around the flat plate, the outer surface of the cord does not extend past the left and right sides of the pods. This can be seen in FIGS. 9 to 11. Similarly, the thickness (468) of the flat plate is such that when the cord is spooled around the flat plate the outer surface of the cord does not extend beyond the front and back surfaces of the first and second pods.

Referring to FIG. 10, if the excess cord (416) wrapped around the flat plate (418) is too thin to frictionally engage the back (417) of the portable PAD (404), “O” rings (419) can be used to increase the thickness of the cord so that it is held tightly in a spooled configuration around the flat plate.

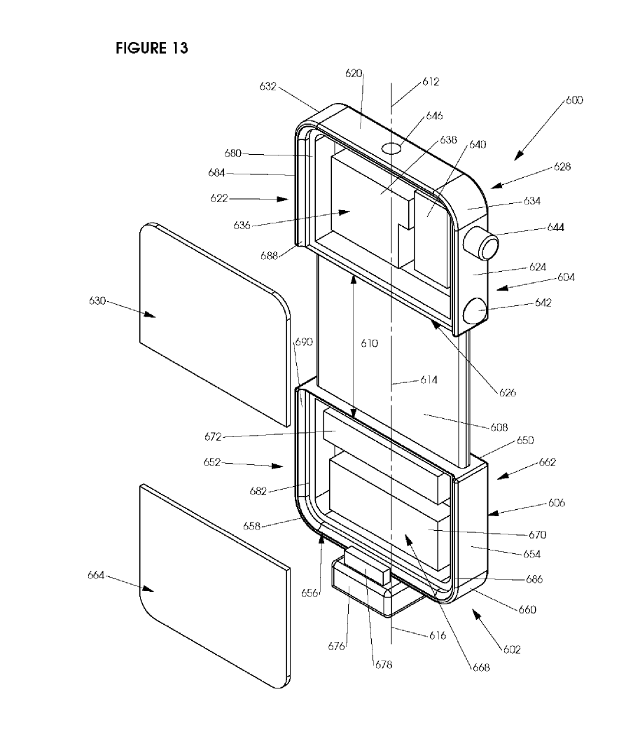

Referring now to FIG. 13, there is shown another embodiment of my invention (600). The base (602) comprises a first pod (604) having a vertical axis (612) a second pod (606) having a vertical axis (616) and a flat plate (608) having a vertical axis (614) and length (610) and disposed between the first and second pods such that their respective vertical axis (612), (614) and (616) are co-axial. The first pod (604) has a top surface (620), a left side (622), a right side (624), a bottom side (626), a back surface (628) and a removable front surface (630). The left side (622) and right side (624) of the first pod (604) are joined to the top side (620) by curved shoulders (632) and (634) respectively. As illustrated, the top, bottom, left and right sides and the back surface of the first pod forms a chamber (636). Removable front surface (630) of the first pod is configured to the profile of the first pod and is sealably placed over the mouth of the chamber (636) to protect contents against moisture and dirt. In the embodiment shown in FIG. 13, chamber (636) is adapted to contain amplification apparatus (638) and control apparatus (640) having switch (642) and a volume control knob (644). In this embodiment a pair of headphones can be plugged into the amplifier by way of plug (646). It is well known that in order to provide a good quality of sound to a set of headphones amplification is required of the audio signal generated by the portable PAD. Therefore, this embodiment of the base of my invention is able to accommodate the apparatus necessary to use larger and more comfortable high impedance headphones in lieu of earphones commonly provided with portable PADs. In yet another embodiment of my invention, it is possible to place a FM radio receiver in chamber (636). In still another embodiment of my invention it is possible to place a microphone in chamber (636) to facilitate recording of the wearer's environment where the portable PAD is adapted for recording. Button switch (642) can be used to switch from the portable PAD to the radio or to the microphone and recording device as desired. A signal processor could be included in chamber (636) to filter out extraneous environmental noise when listening to music or human speech. In another embodiment, chamber (636) can be used to store earphones.

Still referring to FIG. 13, the second pod (606) comprises a top surface (650), a right side (652), a left side (654), a bottom (656), a left shoulder (658) and a right shoulder (660). The second pod also has a back surface (662) and a removable front surface (664). The rear surface, top, bottom, left and right sides form a chamber (668) adapted, in this embodiment, to store additional batteries (670) and (672). The front surface (664) is adapted to seal the mouth of the chamber against moisture and dirt. In this embodiment the base (602) includes a docking apparatus (676) that is adapted to couple with the portable music charging receptacle (not shown) by way of plug (678). The batteries are used to power the amplifier (638) and extend the playing time of the portable PAD. The batteries are operatively connected to the amplifier by means of a suitable connector (not shown) embedded into the flat plate (608). The amplifier is connected to the listening device output plug on the portable PAD. This connection can be integrated into plug (678) with suitable connectors placed within the flat plate.

Still referring to FIG. 13, first pod front surface (630) and second pod front surface (664) are adapted to abut seat (680) and (682) respectively so that the front surfaces are recessed below pod edges (684) and (686). This creates a raised ridge (688) and (690) around front surfaces of the first and second pod which are adapted to receive the back surface of the top and bottom portion of the portable PAD. The result is that, once the cincture is in place, the portable PAD is prevented from slipping off of the base in an up, down or sideways direction.

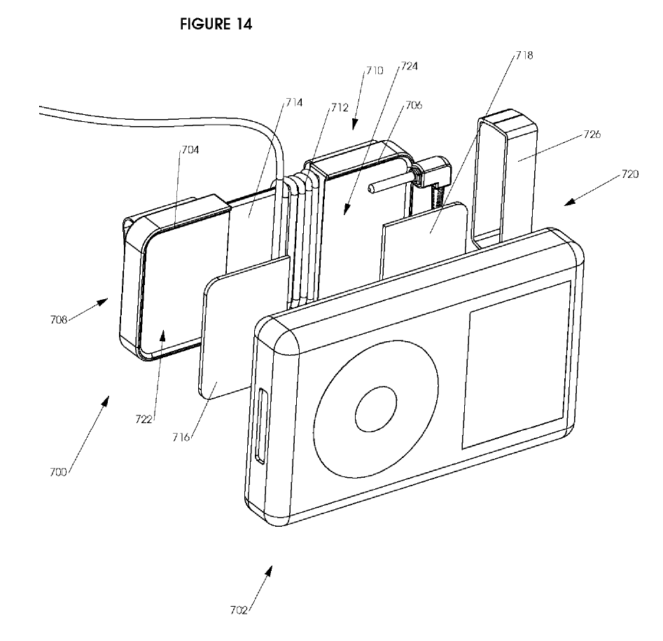

Referring to FIG. 14, there is shown a view of one embodiment my invention (700) showing how the portable PAD (702) fits into the raised ridges (704) and (706) of the first and second pods (708) and (710) respectively. A desired length of excess cord (712) is spooled around the flat plate (714). Double sided adhesive pads (716) and (718) are used to fix the back surface (720) of the portable PAD (702) to the front surface (722) and (724) of each pod. Once the portable music device is placed within the raised ridges a cincture (726) is then placed over the combined base and portable PAD to hold the latter firmly against the former.

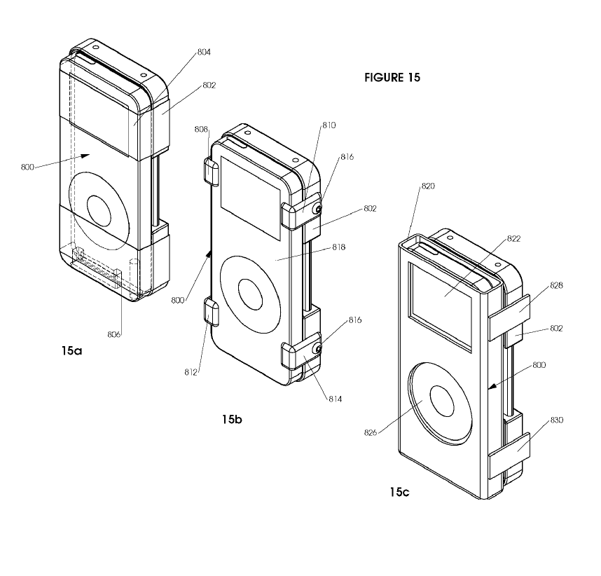

Referring now to FIG. 15a to 15c, there is illustrated three additional means to fix the portable PAD (800) to the base (802) of my invention. FIG. 15a shows that two identical cinctures (804) and (806) can be used. FIG. 15b shows the use of four “L” shaped clamps (808), (810), (812) and (814). The clamps are made from a resilient material such as plastic and are fixed to the base by way of a pivoting fastener (816). The pivoting fastener allows a limited amount of movement of the clamp so that the portable PAD can be easily coupled to the base. Once the portable PAD is placed over the base, the clamps are flexible enough to be able to engage the top surface (818) of the portable PAD in a grasping fashion.

Referring to FIG. 15c there is shown another embodiment of my invention wherein the means to hold the portable PAD (800) to the base (802) comprises a flexible casing (820) adapted to tightly encase the portable PAD. The flexible casing has a first rectangular window (822) adapted for viewing the control display of the portable PAD and a second circular window (826) adapted for viewing the control pads of the portable PAD. Once the portable PAD is inserted into the flexible casing, the casing is mounted by a pair of VELCRO® straps (828) and (830).

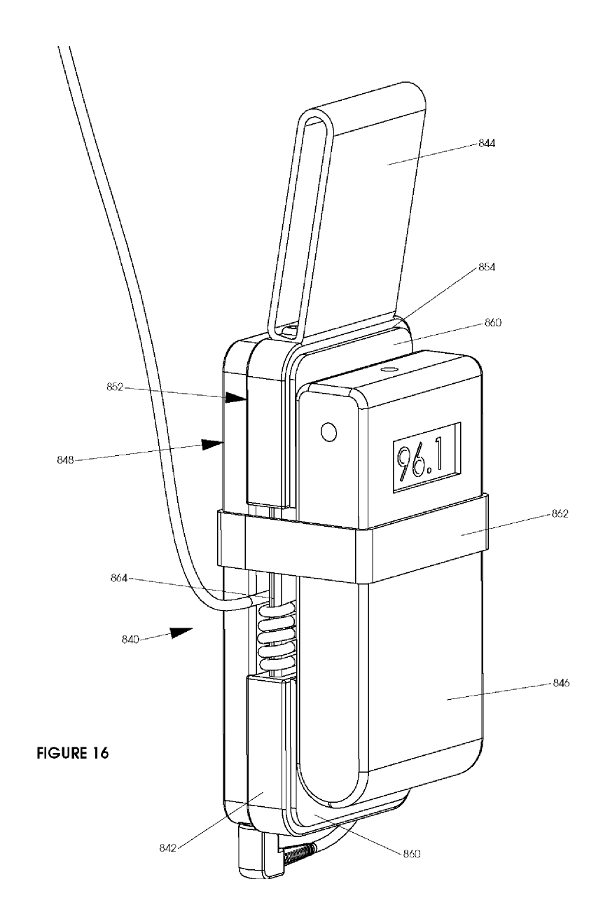

Referring now to FIGS. 11 and 16 there is shown another embodiment of the invention (840) in which the base (842) is coupled to the wearer using a belt loop (844). In this embodiment it is possible to attach two portable PADs to the same base. In this FIG. 16 a small FM radio (846) and an iPOD-type device (848) are attached to the front (852) and back (854) surfaces of the base respectively. The iPOD-type device (848) is fastened to the front surface (852) of the base in the same manner as that shown in FIG. 14. The radio is fastened to the back surface (854) using a double-sided adhesive pad (860). Cincture (862) is large enough to fit over the base, the iPOD-type device and the radio. In order to listen to the radio, the wearer has only to unplug the audio plug (864) from the iPOD-type device and plug it into the radio. Alternatively, a “Y” connection can be used to simultaneously connect both devices to the listening device and one can be chosen over the other by turning the undesired device off and the desired device on. Excess cord is spooled around the flat plate (864).

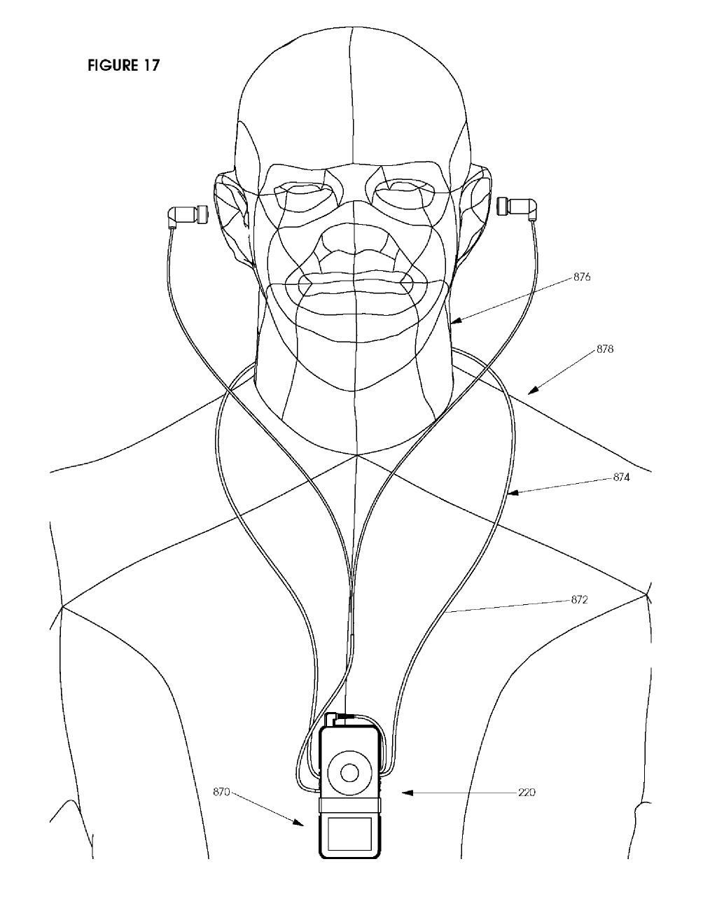

Referring now to FIG. 17, my invention (870) can be hung around the neck of the wearer using the cord (872) as a lanyard. A first coil is of excess cord is spooled around the flat plate and then the lanyard (874) is formed around the neck (876) of the wearer (878). The remaining excess cord is spooled tightly around the flat plate of the base so that the lanyard retains its diameter.

Referring now to FIG. 18, there is shown the same embodiment as FIG. 16 using two portable PADs such as a radio (880) and an iPOD-type device (882). The iPOD-type device is attached to the front surface of the base (884) and the radio is attached to the back of the base. The combined apparatus is attached to the wearer by belt loop (886). In this embodiment the wearer is using a set of headphones (888). Typically such headphones come with a very long cable (890) that is too long to be spooled around the flat plate. In this embodiment, the excess cable can be hung as concentric loops (892) from the cavity (894) created by coupling the base to the portable PADs. In this mode, the length of the cord required between the portable PAD and the head phones can be increased by gently pulling on the cord. This will cause the cord loops to contract if additional cord is required. Alternatively, the user can easily thread excess cord back into the cavity thereby expanding the loops. As previously mentioned, the use of large headphones may require the installation of a small amplifier and additional power in the chambers of the base.

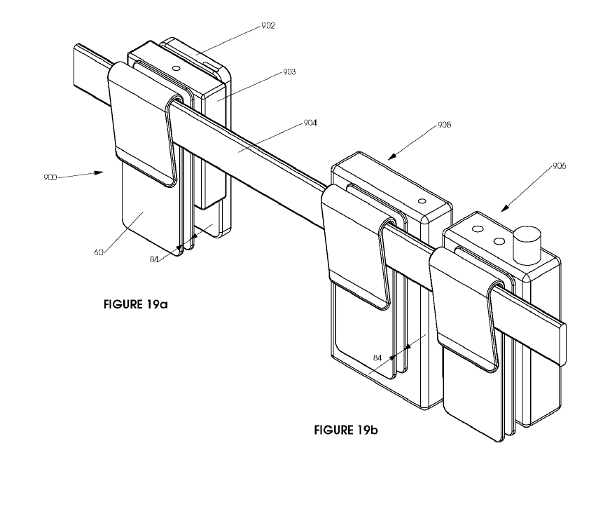

Referring now to FIGS. 19a and 19b there is shown in FIG. 19a one embodiment of my invention (900) mounting a PAD (902) combined with an amplifier (903) and clipped to a belt (904). In FIG. 19b, it is illustrates that multiple PADs (906) and (908) can be mounted to the belt (904) of the wearer.

Also apparent in FIG. 19a is the use of a back plate (60) having no slots. The non-slotted embodiment has a large enough spool width (84) that a small diameter earphone cord may be spooled without the need for access via a side-slot (i.e. the cord's diameter is less than half of the spool's width). The iPod-like device (902) and its auxiliary headphone amplifier (903) are secured using double-sided tape. Also apparent in FIG. 19b is the extra-wide spool width (84) can accommodate a single coil of the thick headphone cord of a high quality headphone. Since the ipod-like device (908) and its companion PAD (906) are clipped adjacent to each other on belt (904), a long and thick headphone cord may be coiled around the combined exterior of their respective cord spools (in a similar manner to that shown in FIG. 18). FIG. 19b illustrates companion PAD 906 as a headphone amplifier other modules, such as an extended battery pack may be substituted or added to the interconnected array of PADs.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. A wearable caddy for a personal audio device, said personal audio device comprising:
a. a front surface and a back surface wherein said front surface includes an operation display and operation controls;
b. a body containing a battery, digital music processing means and amplification means;
c. a bifurcated cord having a diameter, a metallic conducting core and a polymer covering, said bifurcated cord comprising:
i. an audio plug adapted for connection to said body;
ii. a first wire having a first end connected to said audio plug and a second end connected to a first listening device adapted to transmit sound to the wearer;
iii. a second wire having a first end connected to the audio plug and a second end connected to a second listening device also adapted to transmit sound to the wearer wherein said second listening device is identical to said first listening device;
iv. a point of bifurcation located between the first and second wire first and second ends;
v. a first portion in which said first and second wires are joined in a parallel fashion; and,
vi. a second portion in which the first and second wires are separate, wherein said caddy comprises: a front plate, said front plate having a left side, a right side, a top end, a bottom end, a front surface and a back surface; a back plate, said back plate having a left side, a right side a top end, a bottom end, a front surface and a back surface; a plate separating body separating said front plate from and said back plate wherein said plate separating body includes a top surface and a bottom surface thereby creating a space between the front plate and the second plate, said space adapted to receive said first and second portions of said bifurcated cord; and a clip adapted to clasp to a wearer's apparel.

2. The caddy as claimed in claim 1 wherein the plate separating body is adapted to create a predetermined distance between said front plate back surface and said back plate front surface, said distance sufficient to permit the cord first portion and second portion easy spooling around the plate separating body in concentric coils and hold the cord first portion and cord second portion within the space.

3. The caddy as claimed in claim 2 further wherein each of the said concentric coils spooled around the plate separating member mounts at least one polymer “O”-ring thereupon so that said at least one coil mounted polymer “O”-ring is in frictional contact with the front surface of the back plate and the back surface of the front plate to hold the first and second portions of the cord firmly within the space.

4. The caddy as claimed in claim 2 wherein said portable music player is mounted to the front surface of the front plate using a dual-sided adhesive strip.

5. The caddy as claimed in claim 2 wherein the portable music player is mounted to the front surface of the front plate using a combination of male and female VELCRO® pads fixed to the back surface of the portable music player and the front surface of the front plate.

6. The caddy as claimed in claim 4 wherein a transparent self-adhering plastic cover is placed over the front surface of the portable music player, said plastic cover adapted to protect the front surface of the portable music player from dirt and moisture while permitting the wearer to manipulate said operation control means and view said operation display means.

7. The caddy as claimed in claim 1 wherein the separating body has a width and a length, and wherein the separating body is disposed centrally and symmetrically between the front surface of the back plate and the back surface of the front plate and fixed thereto.

8. The caddy as claimed in claim 7 wherein said length and said width of the separating body permit a sufficient space between the front and back plates to spool for storage the first and second portions of the cord.

9. The caddy as claimed in claim 8 wherein the spring clip extends down said back surface of the back plate a distance mid-way between said top end and said bottom end of the back plate.

10. The caddy as claimed in claim 9 wherein the back plate further includes a plurality of cutouts, said plurality of cutouts comprising: a first cutout disposed at the bottom end of the back plate to the left of the separating body and extending upwards to a point above the bottom curve of the plate separating body; a second cutout disposed on the said left side of the back plate and extending from the left side of the back plate to a point adjacent to the plate separating body; a third cutout disposed on the said right side of the back plate and extending from the right side of the back plate to a point adjacent to the plate separating body so that said second and third cutout are opposite each other across the separating body; a fourth cutout disposed on the left side of the back plate proximate to the top end thereof; and, a fifth cutout disposed on the right side of the back plate proximate to the top end thereof such that said fourth cutout and said fifth cutout are opposite each other across the separating body, and wherein the depth of the fourth and fifth cutouts is approximately twice said diameter of the cord.

11. The caddy as claimed in claim 1 wherein the back plate front surface comprises a first stub and a second stub, and wherein the front plate back surface comprises a first raised disc having a first recess and a second raised disc having a second recess.

12. The caddy as claimed in claim 11 wherein said first stub is adapted to press fit within said first recess and said second stub is adapted to press fit within said second recess thereby fixing the front plate to the back plate.

13. The caddy as claimed in claim 12 wherein said first disc and said second disc act together to create a space between the front surface of the back plate and the back surface of the front plate sufficiently wide to accommodate the first and second portions of the cord spooled around the first disc and the second disc.

14. A wearable caddy for a personal audio device, said personal audio device comprising: a front surface and a back surface wherein said front surface includes an operation display and operation controls; a body having a bottom surface said body containing a battery, digital music processing means and, amplification means; a bifurcated cord having a diameter, a metallic conducting core and a polymer covering, said bifurcated cord comprising: an audio plug adapted for connection to said body; a first wire having a first end connected to said audio plug and a second end connected to a first listening device adapted to transmit sound to the wearer; a second wire having a first end connected to the audio plug and a second end connected to a second listening device also adapted to transmit sound to the wearer wherein said second listening device is identical to said first listening device; a point of bifurcation located between the first and second wire first and second ends; a first portion in which said first and second wires are joined in a parallel fashion; and, a second portion in which the first and second wires are separate; wherein said caddy comprises: a front plate, said front plate having a left side, a right side, a top end, a bottom end, a front surface and a back surface; a back plate, said back plate having a left side, a right side a top end, a bottom end, front surface and a back surface; a plate separating body separating said front plate and said back plate wherein said plate separating body includes a top surface and a bottom surface thereby creating a space between the front plate and the second plate, said space adapted to receive said first and second portion of said bifurcated cord; a spring clip integral to said top end of the back plate, said spring clip comprising a top curved surface, a biased portion adapted to clasp to a wearer's apparel, and a flared lip adapted to permit easy attachment to said wearer's apparel; a left side bracket fixed to said front plate left side; a right side bracket fixed to said front plate right side; and, a bottom bracket fixed to said front plate bottom.

15. The caddy as claimed in claim 14 wherein said back plate further includes a plurality of cutouts, said plurality of cutouts comprising: a first cutout disposed at the bottom end of the back plate to the left of the separating body and extending upwards to a point above the bottom curve of the plate separating body; a second cutout disposed on the said left side of the back plate and extending from the left side of the back plate to a point adjacent to the plate separating body; a third cutout disposed on the said right side of the back plate and extending from the right side of the back plate to a point adjacent to the plate separating body so that said second and third cutout are opposite each other across the separating body; a fourth cutout disposed on the left side of the back plate proximate to the top end thereof; and, a fifth cutout disposed on the right side of the back plate proximate to the top end thereof such that said fourth cutout and said fifth cutout are opposite each other across the separating body, and wherein the depth of the fourth and fifth cutouts is approximately twice said diameter of the cord.

16. The caddy as claimed in claim 15 wherein said caddy is adapted to hold a personal audio device that is augmented with an amplifier module attached to said bottom surface thereof.

17. The caddy as claimed in claim 16 wherein said amplifier module includes a volume control dial and a port for inserting the audio plug.

18. The caddy as claimed in claim 17 wherein said left side bracket and said right side bracket are integral to the front plate left and right sides respectively.

19. The caddy as claimed in claim 18 wherein the left side bracket and the right side bracket each have inward facing concave surfaces wherein said inward facing concave surfaces are adapted to conform to the shape of the sides of the personal audio device.

20. The caddy as claimed in claim 19 wherein said the bottom bracket extends from the bottom edge of the front plate and is adapted to the shape of the amplification module.

21. A wearable caddy for a personal audio device, said personal audio device comprising: a front surface and a back surface wherein said front surface includes an operation display and operation controls; a body containing a battery, digital music processing means and, amplification means; a bifurcated cord having a diameter, a metallic conducting core and a polymer covering, said bifurcated cord comprising: an audio plug adapted for connection to said body; a first wire having a first end connected to said audio plug and a second end connected to a first listening device adapted to transmit sound to the wearer; a second wire having a first end connected to the audio plug and a second end connected to a second listening device also adapted to transmit sound to the wearer wherein said second listening device is identical to said first listening device; a point of bifurcation located between the first and second wire first and second ends; a first portion in which said first and second wires are joined in a parallel fashion; and, a second portion in which the first and second wires are separate; wherein said caddy comprises a base onto which said personal audio device is mounted and wherein said base comprises a first pod having a first vertical axis and a second pod having a second vertical axis.

22. The caddy as claimed in claim 21 wherein said second pod is disposed from said first pod a predetermined distance such that said first vertical axis and said second vertical axis are co-axial.

23. The caddy as claimed in claim 22 wherein the pod further comprises a flat plate having a third vertical axis.

24. The caddy as claimed in claim 23 wherein said flat plate has a length equaling said predetermined distance and joins the first and second pods.

25. The caddy as claimed in claim 24 wherein the first pod and the second pod and the flat plate are molded as one piece from suitable thermoplastic materials.

26. The caddy as claimed in claim 25 wherein the personal audio device is mounted to the base by means of a single cincture.

27. The caddy as claimed in claim 26 wherein the personal audio device is mounted to the base by at least one cincture.

28. The caddy as claimed in claim 27 wherein the base is mounted to the wearer by at least one spring clip wherein said at least one spring clip is mounted to the base.

29. The caddy as claimed in claim 28 wherein the base is mounted to the wearer by means of a belt loop wherein said belt loop is mounted to the base.

30. The caddy as claimed in claim 25 wherein: the first pod comprises: a back surface; a front surface; a left side; a top side; a right side; a rim; a first curved shoulder joining said top side to said left side; a second curved shoulder joining the top side to said right side; and, a bottom side, and wherein the second pod comprises: a back surface; a front surface; a left side; a top side; a right side; a rim; a first curved shoulder joining said top side to said left side; a second curved shoulder joining said top side to said right side; and, a bottom side, and wherein the flat plate comprises: a length; a width; a thickness; a front flat surface; a back flat surface; a top end; a bottom end; a left side; and, a right side.

31. The caddy as claimed in claim 30 wherein said flat plate top end is fixed to said first pod bottom end and wherein said flat plate bottom end is fixed to said second pod top end.

32. The caddy as claimed in claim 31 wherein said first pod front surface is removable from the first pod and wherein said second pod front surface is removable from the second pod thereby exposing a first chamber having a mouth within the first pod and a second chamber having a mouth within the second pod.

33. The caddy as claimed in claim 32 wherein the first pod front surface is configured to the profile of the first pod and is sealably placed over said mouth of said first pod first chamber and wherein the second pod front surface is configured to profile the second pod and is sealably place over said mouth of said second pod second chamber.

34. The caddy as claimed in claim 33 wherein the first pod first chamber is adapted to contain amplification apparatus operationally connected to the personal audio device.

35. The caddy as claimed in claim 34 wherein the second pod second chamber is adapted to contain batteries operationally connected to the personal audio device and adapted to extend the playing time of the personal audio device.

36. The caddy as claimed in claim 32 wherein the first pod first chamber is adapted to contain a radio.

37. The caddy as claimed in claim 32 wherein the first pod first chamber is adapted to contain audio recording apparatus.

38. The caddy as claimed in claim 32 wherein the first pod front surface is seated below said first pod rim and wherein the second pod front surface is seated below said second pod rim so that once the personal audio device is placed on top of the first pod front surface and second pod front surface the back surface of the personal audio device sits below the first pod rim and second pod rim thereby preventing the personal audio device from slipping off of the base.

39. The caddy as claimed in claim 38 wherein the personal audio device is fixed to the base by means of a double sided adhesive pad between the front surfaces of the first and second pods and the back surface of the personal audio device.

40. The caddy as claimed in claim 39 wherein the personal audio device is fixed t the base by means of at least one cincture.

41. The caddy as claimed in claim 40 in which at least one portable audio player is fixed to the base.

42. A wearable caddy for simultaneously transporting a Personal Audio Device, and its associated earphone cord, said Personal Audio Device having a front surface and a back surface, wherein said caddy is comprised of: a first thin plate having a front surface and a back surface, wherein said front surface is adapted for fixation to said back surface of said Personal Audio Device; a second thin plate having a front surface and a back surface, wherein said second plate back surface is adapted for fixation to the wearer's apparel by means of a spring clip element; and, a spacer element symmetrically joining the back surface of said first thin plate to the front surface of said second thin plate in order to form a spool for receiving coils of said earphone cord.
